(19) United States
(12) Patent Application Publication
(10) Pub. No.: US 2013/0003047 A1
(43) Pub. Date: Jan. 3, 2013

(54) METHOD FOR CONTACTLESS DETERMINATION OF THE THICKNESS OF A WEB OF MATERIAL

(76) Inventors: Pekka Typpo, Pearland, TX (US); Willy Knabe, Heidenheim (DE); Jörg Bröckel, Gerstetten (DE)

(21) Appl. No.: 13/339,472

(22) Filed: Dec. 29, 2011

Related U.S. Application Data
(63) Continuation of application No. PCT/EP2010/057887, filed on Jun. 7, 2010.
(60) Provisional application No. 61/222,634, filed on Jul. 2, 2009.

(51) Int. Cl. G01B 11/06

(52) U.S. Cl. 356/72

(57) ABSTRACT

A method for the contactless determination of the thickness of a web of material, for example, a web of fibrous material, with a sensor array including at least two measurement plates includes guiding the web between the at least two measurement plates. An air cushion is generated between each measurement plate and the web so as to keep the measurement plates at a distance from the web. A sensor array is used which includes at least one magnetic sensor as well as optical distance measuring devices, wherein the distance between the measurement plates arranged on opposite sides of the web is magnetically determined, while the distance between a measurement plate and the web is determined using optical distance measuring devices which are located on the measurement plates arranged on opposite sides of the web.

This is a continuation of PCT application No. PCT/EP2010/057887, entitled “METHOD FOR THE CONTACTLESS DETERMINATION OF THE THICKNESS OF A WEB OF MATERIAL”, filed Jun. 7, 2010, which is incorporated herein by reference.

### BACKGROUND OF THE INVENTION

1. Field of the Invention

The present invention relates to a method for contactless determination of the thickness of a material web, for example, a fibrous material web, with a sensor arrangement including at least two optical measurement plates between which the web can be guided, whereby an air cushion is generated respectively between each measurement plate and the web so as to keep the measurement plates at a distance from the web.

2. Description of the Related Art

Hitherto a magnetic or optical method was used for contactless measurement of the thickness of a material web. Both methods however, permit only measurements of thicker papers, in particular papers having a thickness of >50 micrometers (μm), since—based on the method—the required accuracy is not achieved with thinner papers.

Optical thickness sensors for contactless determination of the thickness of a material web, especially a fibrous web are known from publications EP 1 855 082 A1 and EP 1 855 083 A1.

In contactless measuring of paper thickness the distance between the optical measuring units, or respectively measurement plates which are arranged on opposite sides of the material web is to be determined on the one hand and on the other hand the distances between these measuring units or respectively measurement plates and the material web are to be determined, whereby the distances between the 3 measuring units and the material web occurs by means of an optical measurement. The optical measuring units, which are arranged on opposite sides of the material web, must be positioned in precisely the same optical axis in order to eliminate faulty measurements due to a paper web which is not progressing perpendicular to the optical axis.

In particular, due to the air build-up of the moving web tilting can occur between the optical measuring units or measuring heads arranged on opposite sides of the web, resulting in an erroneous measurement.

Such tilting between an upper and a lower optical measuring unit or respectively their measurement plates 12, 14 caused for example by the air build-up of the moving web or respectively fibrous web 10 can be seen in FIG. 1 which illustrates a schematic depiction of a conventional device for contactless determination of the thickness, wherein only one optical sensor 16 or respectively 18 is allocated to a respective measuring unit. In a conventional device of this type tilting of the measurement plates 12, 14 cannot be compensated. Therefore, in a conventional device of this type with only one path of rays on a respective material web an inaccurate measurement results.

What is needed in the art is a method for accurate contactless determination of the thickness of a material web with which also on thinner webs or respectively papers and on webs or respectively papers having a thickness of <50 μm are obtained.

### SUMMARY OF THE INVENTION

The present invention provides a sensor arrangement used for determining a thickness of a material web which includes at least one magnetic sensor as well as also optical distance measuring devices whereby the distance between the measurement plates which are arranged on opposite sides of the web, and the distance between a respective measurement plate and the web is measured through optical distance measurement devices which are provided on the measurement plates which are arranged on opposite sides of the web. According to the present invention a magnetic and an optical measuring method are therefore combined with each other. The measurement plates can always be kept at a constant distance from the web by means of air cushions.

In order to adjust the measurement plate distance to a constant value, the magnetically determined measurement plate distance may also be utilized. Magnetic determination of the distance between the measurement plates which are arranged on opposite sides of the web occurs, for example, through a magnetic measurement on at least three different locations.

The optical determination of the distance between a respective measurement plate and the web may occur respectively through at least three optical distance measuring devices provided on a respective measurement plate.

According to a first embodiment of the present inventive method, the thickness of the web is established from the magnetically determined distance between the measurement plates which are arranged on opposite sides of the web and the optically determined distances between the measurement plates which are arranged on opposite sides of the web, and the web. For this purpose an evaluation unit can be used with an appropriate algorithm in order to calculate the web thickness.

Since the magnetic sensors and the optical sensors cannot be arranged in the same location on the measurement plate, the magnetically determined distance values between the measurement plates which are arranged on opposite sides of the web are converted from the location of the magnetic sensors to the location of the optical sensors, whereby the required accuracy is achieved through the conversion of the magnetic measured value to the location of the optical sensors.

An additional improvement in the accuracy is achieved in that always all magnetically determined distance values between the measurement plates which are arranged on opposite sides of the web are used at the locations of the magnetic sensors to calculate the respective distance value at the location of the optical sensor. The magnetic determination of the distance between the measurement plates which are arranged on opposite sides of the web occurs, for example, through at least one magnetic sensor provided on the measurement plate on one side of the web. For the purpose of such magnetic determination of the measurement plate distance through the at least one magnetic sensor provided on one side of the web, the measurement plate on the opposite side of the web is at least partially formed of ferrite.

According to second embodiment of the inventive method, the magnetic determination of the distance between the measurement plates which are arranged on opposite sides of the web occurs through at least three magnetic sensors which are provided on the measurement plate on one side of the web.

A respective optical distance measuring device or respectively optical sensor of the inventive sensor arrangement may moreover be configured in particular as described in EP 1 855 082 A1 or EP 1 855 083 A1.

An optical sensor with a device to determine the distance to an object is known for example from EP 1 855 082 A1, whereby at least one lens arrangement is provided in order to focus light from a light source, such as a laser light source onto the object and to collect light reflected and scattered from the object, whereby an aperture element with a circular aperture is provided in order to form a circular light beam from the reflected and scattered light, and a detector system structured and arranged to receive the circular light beam, wherein the detector system is sensitive to the light beam diameter, whereby determination of the distance to the object is based upon signals from the detector system. An analyzer, allocated to the detector system can be configured for determination of the thickness of the object. Hereby a lens arrangement can be provided on both sides of the object and the lens arrangements provided on different sides may feature a defined distance from each other. The thickness of the object may in this case be determined in particular in that the respectively defined distances between lens arrangements provided on both sides of the object are added to the object and the thus obtained sum is subtracted from the defined or respectively determined distance between the lens arrangements.

EP 1 855 083 A1 describes a comparable optical sensor with which a light source of low coherence is used which can include a super-luminescence diode. An optical window may be provided between a respective lens arrangement and the object.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic depiction of a conventional device for contactless determination of a thickness of an object; and

FIG. 2 is a schematic illustration of a measurement plate on which several magnetic sensors as well as several optical sensors are arranged according to the present invention.

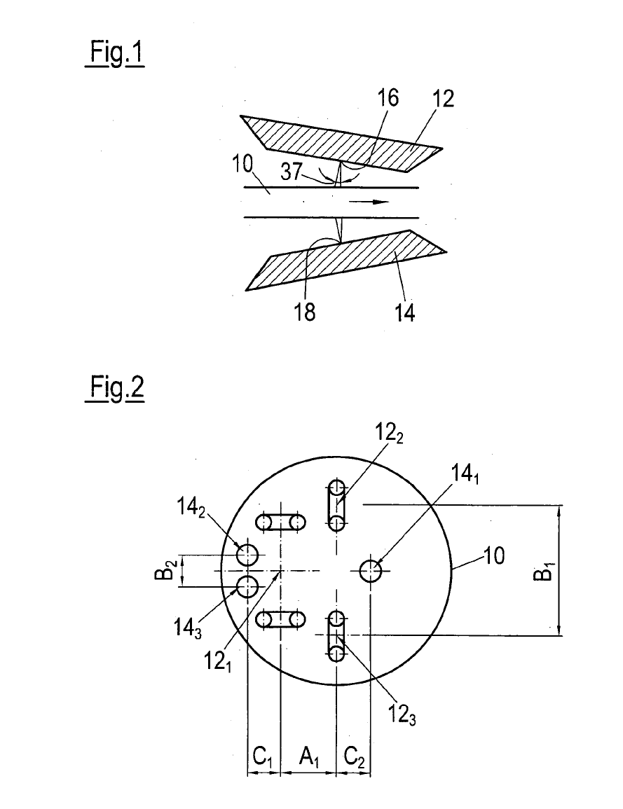

Corresponding reference characters indicate corresponding parts throughout the several views. The exemplification set out herein illustrates one embodiment of the invention and such exemplification is not to be construed as limiting the scope of the invention in any manner.

### DETAILED DESCRIPTION OF THE INVENTION

Referring now to the drawings, and more particularly to FIG. 2, there is shown measurement plate 10 on which several magnetic sensors 12₁-12₃, as well as several optical sensors 14₁-14₃, are arranged. The measurement plate which is provided on the opposite side of the web and which is not illustrated here can be formed at least partially or totally of ferrite and serves as counterpart to the magnetic sensors on the measurement plate shown in FIG. 2, for example upper measurement plate 10. The non-illustrated, for example lower measurement plate also includes several optical sensors which are located exactly opposite optical sensors 14₁-14₃ of illustrated upper measurement plate 10.

According to the present invention therefore, a method for contactless determination of the thickness of a material web, such as a fibrous web material with a sensor arrangement including at least two optical measurement plates between which the web can be guided is cited, whereby an air cushion is generated respectively between each measurement plate and the web so as to keep the measurement plates at a distance from the web. The fibrous web may be a paper or cardboard web.

A sensor arrangement is hereby used which includes at least one magnetic sensor 12₁-12₃, as well as also optical distance measuring devices 14₁-14₃. The distance between the measuring plates which are arranged on opposite sides of the web is hereby measured, and the distance between a respective measurement plate and the web is determined through optical distance measuring devices 14₁-14₃ which are provided on the measurement plates which are arranged on opposite sides of the web. The measurement plates can be kept at a constant distance from the web through the air cushions.

As indicated in FIG. 2, the magnetic determination of the distance between the measurement plates which are arranged on opposite sides of the web can occur through a magnetic measurement on at least three different locations whereby in the current example only three such magnetic measurements are provided.

The optical determination of a distance between a respective measurement plate and the web can—also as indicated in FIG. 2—occur respectively through at least three distance measuring devices which are provided on a respective measurement plate, whereby in the current example respectively only three optical distance measuring devices 14₁-14₃ are provided on the measurement plates which are arranged on opposite sides of the web.

The thickness of the web can be established from the magnetically determined distance between the measurement plates which are arranged on opposite sides of the web and the optically determined distances between the measurement plates, which are arranged on opposite sides of the web, and the web. Here, in the first instance the magnetically determined distance values in positions 12ₖ, 12₂, 12₃ are computed onto positions of optical sensors 14ₖ, 14₂, 14₃. The geometric distances which are used for the calculation of the positions of the optical sensors are also defined in FIG. 2.

H12=H1+(C₁/A₁)*[H1−(H2+H3)/2]+[(B₂/2)/B₁]*(H2−H3)

H13=H1+(C₁/A₁)*[H1−(H2+H3)/2]+[(B₂/2)/B₁]*(H2−H3)

H11=(H2+H3)/2+(C₂/A₁)*[(H2+H3)/2−H1]

H1: Magnetic measurement on 12₁
H2: Magnetic measurement on 12₂
H3: Magnetic measurement on 12₂
H11: Magnetic values calculated on 14₁
H12: Magnetic values calculated on 14
H13: Magnetic values calculated on 14₃

To calculate the actual thickness value of the web an evaluation device with an appropriate algorithm can be provided which suitably combines all determined measured values or respectively through which the web thickness is accordingly calculated.

As already explained, the magnetic determination of the distance between the measurement plates which are arranged on opposite sides of the web occurs, for example, through at least one magnetic sensor 12₁-12₃ provided on measurement plate 10 on one side of the web.

For the purpose of magnetic determination of the measurement plate distance through at least one magnetic sensor 12₁-12₃ provided on one side of the web, the measurement plate on the opposite side of the web can be formed partially or totally of ferrite.

The magnetic determination of the distance between the measurement plates which are arranged on opposite sides of the web can occur through at least three magnetic sensors 12₁-12₃ provided on measurement plate 10 on one side of the web, whereby in the embodiment of the referenced measurement plate 10 illustrated in FIG. 2 only three such magnetic sensors 12₁-12₃ are provided.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### COMPONENT IDENTIFICATION

| | |
|---|---|
| 10 | Measurement plate |
| 12₁ | Magnetic sensor |
| 12₂ | Magnetic sensor |
| 12₃ | Magnetic sensor |
| 14₁ | Optical distance measuring device |
| 14₂ | Optical distance measuring device |
| 14₃ | Optical distance measuring device |
| A₁, B₁, B₂, C₁, C₂ | Distances |

What is claimed is:

1. A method for contactless determination of a thickness of a fibrous material web, the method comprising the steps of:
providing a sensor arrangement including at least two optical measurement plates, at least one magnetic sensor and a plurality of optical distance measuring devices provided on said at least two optical measurement plates arranged on opposites sides of the fibrous material web;
guiding the fibrous material web between said at least two optical measurement plates;
generating an air cushion between each of said at least two optical measurement plates and the fibrous material web to keep said at least two measurement plates at a predefined distance from the fibrous material web; and
measuring a distance between said at least two optical measurement plates arranged on opposite sides of the fibrous material web and a distance between each of said at least two optical measurement plates and the fibrous material web with said plurality of optical distance measurement devices.

2. The method according to claim 1, wherein said air cushion between each of said at least two optical measurement plates and the fibrous material web always keep said at least two optical measurement plates at a constant predefined distance from the fibrous material web.

3. The method according to claim 2, further comprising the step of magnetically determining said distance between said at least two optical measurement plates arranged on said opposite sides of the fibrous material web through a magnetic measurement on at least three different locations.

4. The method according to claim 3, further comprising the step of optically determining the distance between each of said at least two optical measurement plates and the fibrous web with at least three optical distance measuring devices provided on said at least two optical measurement plates.

5. The method according to claim 4, further comprising the step of establishing the thickness of the fibrous material web from said magnetically determined distance between said at least two optical measurement plates arranged on opposite sides of the fibrous material web and said optically determined distances between each of said at least two optical measurement plates and the fibrous material web.

6. The method according to claim 5, further comprising the step of converting a value of said magnetically determined distance between said at least two optical measurement plates at a location of said at least one magnetic sensor to a location of said plurality of optical sensors.

7. The method according to claim 6, wherein all of said magnetically determined distance values between said at least two optical measurement plates are used at said location of said at least one magnetic sensor to calculate a respective distance value at said location of said plurality of optical sensors.

8. The method according to claim 7, wherein said magnetic determination of said distance between said at least two optical measurement plates occurs through at least one magnetic sensor provided on one of said at least two optical measurement plates on one side of the fibrous material web.

9. The method according to claim 8, wherein said other of said at least two optical plates on the opposite side of the fibrous material web is formed at least partially of ferrite.

10. The method according to claim 9, wherein said at least one magnetic sensor is at least three magnetic sensors provided on said measurement plate on said one side of the fibrous material web, said magnetic determination of said distance between said at least two optical measurement plates occurring through said at least three magnetic sensors.
